(19) United States
(12) Patent Application Publication
(10) Pub. No.: US 2008/0250959 A1
(43) Pub. Date: Oct. 16, 2008

(54) Loading Device, Input Section, Method For Loading A Printing Plate, Computer System And Computer Program Product

(76) Inventor: Herman Van de Straete, Deurne (BE)

Correspondence Address: QUARLES & BRADY LLP, 411 E. WISCONSIN AVENUE, SUITE 2040, MILWAUKEE, WI, 53202-4497, US

(21) Appl. No.: 12/100,471

(22) Filed: Apr. 10, 2008

(30) Foreign Application Priority Data
Apr. 11, 2007 (EP) 07105988.5

(51) Int. Cl. B41L 47/14

(52) U.S. Cl. 101/477

(57) ABSTRACT

The invention relates to a loading device for loading a printing plate from a multiple plate stack to an input section of a plate imaging bed in an imaging system for performing a computer-to-plate imaging process on printing plates. The loading device comprises a picking unit for picking a printing plate from the multiple plate stack and transporting the plate to the input section. Further, the loading device is arranged to release the plate after the plate has been positioned in a starting position for autonomous manipulation by the imaging system.

The invention relates to a loading device for loading a printing plate from a multiple plate stack to an input section of a plate imaging bed in an imaging system for performing a computer-to-plate imaging process on printing plates, the loading device comprising a picking unit for picking a printing plate from the multiple plate stack and for transporting the plate to the input section.

The computer-to-plate imaging process is a digital technology transferring text and/or images directly onto the printing plate by means of a radiation exposure unit, in which process an intermediate film production is bypassed.

A known imaging system for performing a computer-to-plate imaging process on printing plates comprises a plate imaging bed for exposing radiation to a printing plate, the bed being provided with an input section for receiving a printing plate and an output section for transferring the printing plate to a chemical processing unit. In operation, a known loading device loads a printing plate from a multiple plate stack to the input section of the plate imaging bed. Subsequently, the printing plate is processed by the imaging system and then transported to the output section of the imaging system. Then, the printing plate is transferred to an optional external conveyor system or a chemical processing unit, for plate types that require chemical processing. The conveyor or chemical processing unit is positioned adjacent the output section of the imaging bed for optional further processing.

In the process of loading the printing plate to the input section of the plate imaging bed, the picking unit of the loading device picks the printing plate from the stack of printing plates and transports the plate to the input section. Then, the picking unit releases the printing plate. Subsequently, a separate position mechanism adjusts the position of the printing plate, so as to arrive at a starting position of the printing plate for autonomous manipulation by the imaging process.

A disadvantage of such a loading procedure is that the whole process causes time, viz. firstly for the loading process and secondly for the positioning process in the starting position. Further, movements of separate devices have to be synchronized with respect to each other in order to avoid collisions and/or inaccuracies. In addition, if the input section of the imaging bed is not entirely horizontal, but slightly tilted, the received printing plate tends to drift away, thereby rendering the whole procedure even more complex and time consuming.

It is an object of the invention to provide a loading procedure, wherein the disadvantages identified above are reduced. In particular, the invention aims at obtaining a simplified loading procedure. Thereto, according to an aspect of the invention, the loading device is further arranged to release the plate after the plate has been positioned in a starting position for autonomous manipulation by the imaging system.

By first bringing the printing plate in the starting position and then releasing the plate, the transporting and positioning process are elegantly integrated, thus obtaining a simplified loading procedure. As a consequence, the whole loading process can be accelerated, thus saving processing time. Further, when dealing with tilted input sections of plate imaging beds, the drift away effect of the released printing plate can be counteracted as the plate is not released when the plate has not arrived in the right starting position, thereby simplifying a plate location correction procedure.

By associating the loading device with a processor that is connected with at least one position detector for detecting the starting position of the printing plate and for sending a start position signal to the processor, the processor being arranged to send a release signal to the loading device for releasing the printing plate upon receipt of the start position signal of the at least one position detector, the positioning process is further enhanced by a feedback loop. If the Tight start position of the printing plate is detected, the generation of appropriate signals can than initiate the release process. Hereby, a fast, simple and robust release process is obtained.

It is noted that the invention further relates to an input section of a plate imaging bed, the input section being arranged for receiving a print plate from a picking unit.

It is also noted that the invention relates to a method.

The invention further relates to a computer system.

In addition, the invention relates to a computer program product.

Other advantageous embodiments according to the invention are described in the following claims.

By way of example only, embodiments of the present invention will now be described with reference to the accompanying figures in which

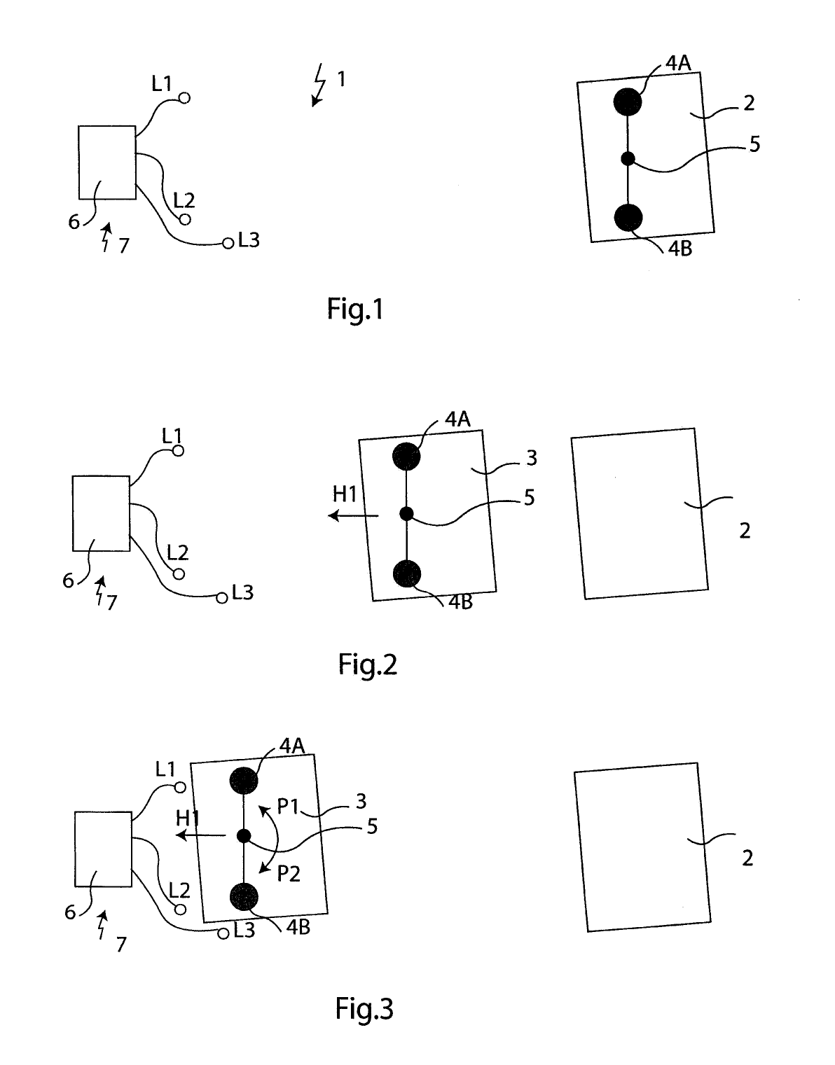

FIG. 1 shows a schematic top view of a first embodiment of a loading device according to the invention in a first state;

FIG. 2 shows a schematic top view of the loading device of FIG. 1 in a second state;

FIG. 3 shows a schematic top view of the loading device of FIG. 1 in a third state;

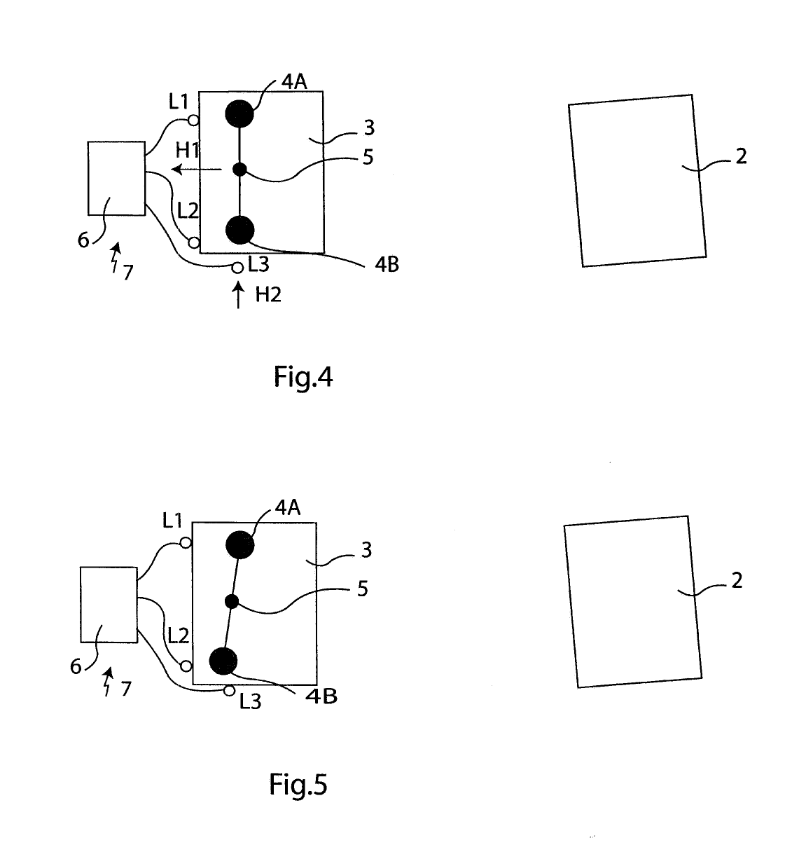

FIG. 4 shows a schematic top view of the loading device of FIG. 1 in a fourth state;

FIG. 5 shows a schematic top view of the loading device of FIG. 1 in a fifth state;

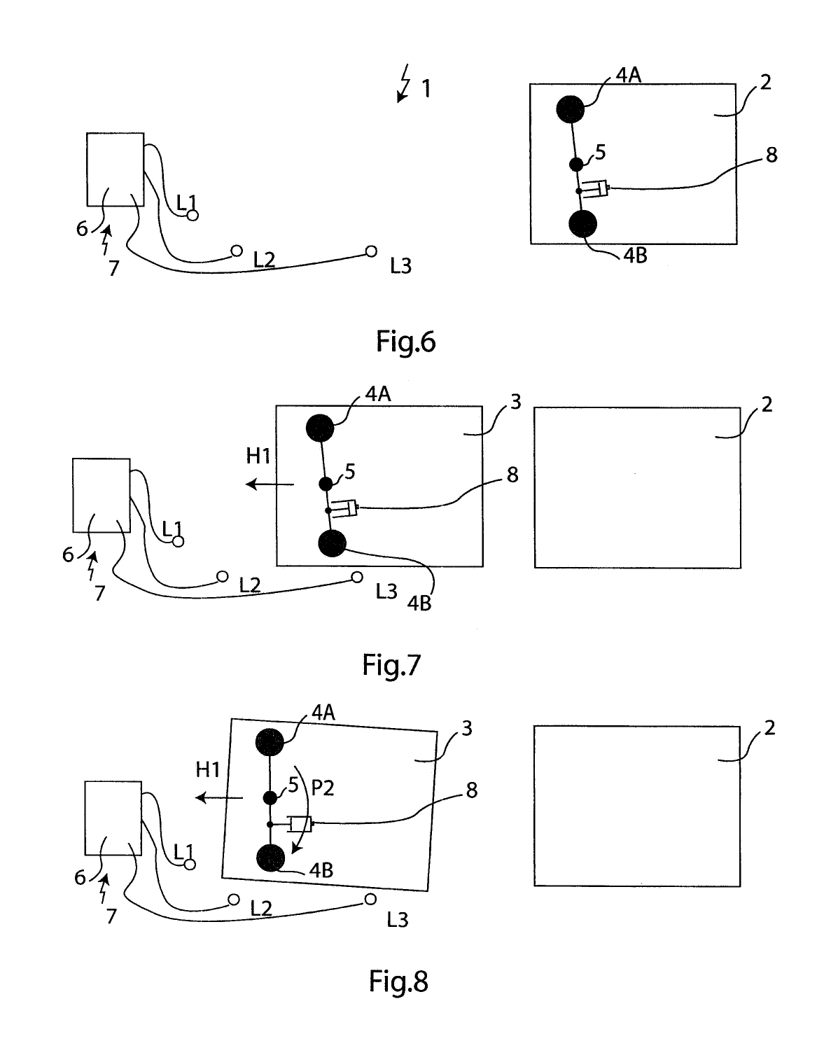

FIG. 6 shows a schematic top view of a second embodiment of a loading device according to the invention in a first state;

FIG. 7 shows a schematic top view of the loading device of FIG. 2 in a second state;

FIG. 8 shows a schematic top view of the loading device of FIG. 2 in a third state;

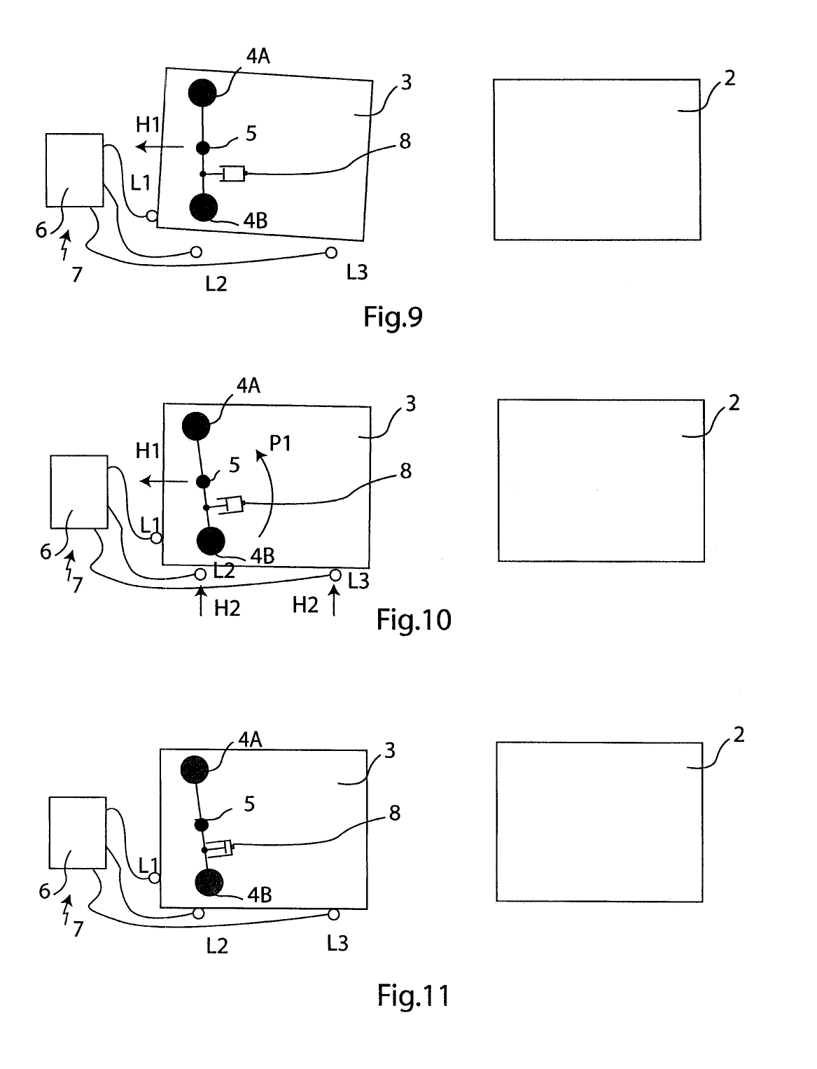

FIG. 9 shows a schematic top view of the loading device of FIG. 2 in a fourth state;

FIG. 10 shows a schematic top view of the loading device of FIG. 2 in a fifth state; and

FIG. 11 shows a schematic top view of the loading device of FIG. 2 in a sixth state.

The figures are merely schematic views of preferred embodiments according to the invention. In the figures, the same reference numbers refer to equal or corresponding parts.

FIG. 1 shows a schematic top view of a loading device 1 according to the invention in a first state. The loading device comprises a picking unit for picking a printing plate 3 from a multiple plate stack 2 and for transporting the plate to an input section of a plate imaging bed in an imaging system for performing a computer-to-plate imaging process. After the input section receives the printing plate 3, the printing plate 3 is autonomously manipulated by the imaging system and exposed to radiation from a radiation exposure unit that is mounted on the plate imaging process and that can comprise an imaging array or a scanning beam based exposure system such as a rotating polygon laser module. Then, the printing plate is transported to the output section of the imaging system and transferred to a chemical processing unit that is placed near the output section.

The picking unit comprises a pair of engagement elements 4A, 4B for picking the printing plate 3, wherein the pair of engagement elements 4A, 4B during operation is pivotable with respect to a substantially vertical pivot axis 5, so that the printing plate 3 can pivot with respect to the vertical pivot for proper positioning of the plate 3 in relation with the input section of the plate imaging bed. In the first embodiment, shown in FIG. 1, the pair of engagement elements 4A, 4B are free to pivot with respect to the vertical pivot axis 5. In principle, also other degrees of freedom can be realized, e.g. by permitting free movement of the pair of engagement elements 4A, 4B in a substantially horizontal plane. The engagement elements 4A, 4B are implemented as vacuum naps. However, also other engagement elements can be used, such as gripping elements gripping the printing plate 3 near its corners.

The input section of the plate imaging bed that is arranged for receiving the printing plate 3, is provided with at least one position detector L₁, L₂, L₃ for detecting a starting position of the printing plate 3 for autonomous manipulation by the imaging system. In the current embodiment according to the invention, three position detectors L₁, L₂, L₃ are employed. In principle however, also other numbers of position detectors can be used, e.g. four or five position detectors, or. merely one position detector.

The position detectors L₁, L₂, L₃ are connected with a processor 6 thus forming a computer system 7 for enabling the loading device to operate properly. If a position detector L₁, L₂, L₃ detects a starting position of a printing plate 3 to be processed by the imaging system, the detector L₁, L₂, L₃ generates a start position signal and sends it to the processor 6 for processing. After receipt of start position signals of a predefined number of position detectors L₁, L₂, L₃, the processor 6 generates a release signal and sends it to the loading device 1 for releasing the printing plate 3. Via the thus obtained feedback loop, the loading device 1 is enabled to perform a positioning step of the printing plate 3 before releasing the printing plate 3. In particular, the printing plate 3 can in this manner be brought in a starting position for autonomous manipulation by the imaging system.

In the first state, shown in FIG. 1, the loading device 1 picks the printing plate 3 from the multiple plate stack 2 by means of the picking unit provided with the pair of engagement elements 4A, 4B implemented as vacuum naps. In a second state that is shown in FIG. 2, the picking unit transports the printing plate 3 towards the input section of the imaging bed. In this process, the printing plate 3 is moved along a first substantially horizontal path H₁, wherein a long side of the printing plate 3 is a front side. The transport movement is actuated by an actuator for enabling a substantially horizontal movement of the engagement elements 4A, 4B. In a third state, shown in FIG. 3, the printing plate 3 abuts against two position detectors L₁, L₂ being arranged along a long side of the planting plate 3 and detecting a starting position of the printing plate 3. The two position detectors L₁, L₂ generate and send a start position signal to the processor 6 which sends a stop signal to the loading device I for stopping the horizontal movement of the printing plate 3.

The position detectors L₁, L₂, L₃ comprise each a contacting pin extending in a substantially vertical direction to enable abutment by the printing plate 3. If the position detectors L₁, L₂, L₃ sense abutment by the printing plate 3, a start position of the printing plate 3 is detected. It is noted however, that the position detectors could also be implemented otherwise., e.g. as photo detectors.

Further, by providing the abutment feature, the printing plate 3 is enabled to pivot with respect to the vertical pivot axis 5, thereby obtaining a proper orientation wherein the printing plate 3 abuts against both position detectors L₁, L₂ arranged along the long side of the printing plate 3. The detectors L₁, L₂ arranged along the long side of the printing plate 3 have a fixed position with respect to the upper surface of the input section of the plate imaging bed.

In a fourth state, shown in FIG. 4, the third position detector L₃ being arranged along a short side of the received printing plate 3, moves along a second, substantially horizontal path H₂ towards the printing plate 3, the second path H₂ being substantially transverse with respect to the first horizontal path H₁, until the third position detector L₃ detects the printing plate 3. Upon detection by the third position detector L₃ a third start position signal is generated and sent to the processor 6 which then generates and sends a stop signal for stopping the movement of the third position detector L₃. After stopping the movement of the third position detector, the loading device 1 has arrived in a fifth state, shown in FIG. 5, wherein the printing plate 3 is positioned in a starting position for autonomous handling by the imaging system The position of the printing plate 3 in the direction of the second substantially horizontal path H₂ is then defined, e.g. by means of a decoder on a motor driving the third position detector L₃. The processor 6 generates and sends a release signal to the loading device 1 and the picking unit releases the printing plate 3. The printing plate 3 is ready for processing by the imaging system. As an example embodiment, the detection pins L₁, L₂, L₃, translate downwards below the upper surface of the input section, the printing plate 3 is transported to a further section of the plate imaging bed and the detection pins are translated upwardly to their initial position. The loading device can now load a further printing plate from the multiple plate stack 2 to the input section of the plate imaging bed.

It is noted that the long and short side, respectively, of the printing plate 3 denotes the long and short side, respectively, of the printing plate 3 forming boundaries of the upper and lower side of the printing plate 3.

It is further noted that also other numbers of position detectors can be chosen along the long and short side, respectively, of the printing plate 3 to be positioned in the starting position, e.g. one position detector along the long side and two position detectors along the short side of the printing plate 3.

The above-described embodiment of the loading device 1, shown in FIGS. 1-5 is especially suitable for handling printing plates in a so-called portrait orientation. In a second embodiment of the loading device 1 that is described below in relation with FIGS. 6-11, printing plates can properly be handled in a landscape orientation.

FIG. 6 shows a schematic top view of a second embodiment of a loading device 1 according to the invention in a first state. Here, the multiple plate stack 2 is oriented transverse with respect to the multiple plate stack 2 in FIG. 1. Further, the loading device 1 comprises a pivot actuator 8 for pivoting the pair of engagement elements 4A, 4B with respect tot he substantially vertical pivot axis 5, so that the orientation of the picked printing plate 3 can actively be adjusted by the loading device 1. In the first state the picking unit picks a printing plate 3 from the stack 2. In a second state, shown in FIG. 7, the picked printing plate 3 is transported to the input section of the imaging bed along the first substantially horizontal path H₁. During this process, in a third state, the printing plate 3 is pivoted clockwise P₂ by means of the pivot actuator 8, as shown in FIG. 8, so that the printing plate 3 is tilted with respect to the aimed starting position. Then, pivoting of the printing plate 3 is released. In a fourth state, shown in FIG. 9, a short side of the printing plate 3 hits a position detector L₁ which generates a start position signal to be processed by the processor for stopping the horizontal movement of the printing plate 3 along the first horizontal path H₁. Preferably, the position detector L₁ is fixed with respect to the surface of the input section of the imaging bed. Subsequently, in a fifth state, shown in FIG. 10, two position detectors L₂, L₃, arranged along a long side of the printing plate 3 move towards the printing plate along the second horizontal path H₂, substantially transverse with respect to the first horizontal path H₁. In this process, one of the two detectors L₃ hits a long side of the printing plate 3 and causes the printing plate 3 to perform a pivoting movement with respect to the vertical axis 5 in a counter clockwise direction P₁, thereby arriving at the right starting position of the printing plate 3. Meanwhile, the position detector L₃ generates and sends a start position signal to the processor 6. However, by the above-mentioned counter clockwise movement of the printing plate 3 it might happen that the printing plate 3 does not contact the position detector L₁ arranged along the short side of the printing plate 3. Therefore, optionally, the loading device 1 is arranged to activate the pivot actuator 8 to counteract the counter clockwise pivoting movement of the printing plate 3, so that the printing plate 3 abuts again against the position detector L1 arranged along a short side of the printing plate 3. After detecting that the printing plate 3 again abuts against the position detector L1, the pivot actuator 8 is again de-activated, thereby releasing pivoting of the printing plate 8. When the second of the two detectors L₂ hits the long side of the printing plate 3, in a sixth state shown in FIG. 11, it also generates and sends a start position signal to the processor which than stops movement of the two position detectors along the second horizontal path H₂. As in the first embodiment of the loading device, the printing plate 3 is now released.

Optionally, the orientation of the pair of engagement elements is initialized before picking the printing plate 8 from the stack by means of the pivot actuator 8.

The method according to the invention, especially for processing signals, can be implemented using hardware components and/or software components formed as computer program products.

The invention is not restricted to the embodiments described herein. It will be understood that many variants are possible.

Instead of using a multiple number of position detectors, also a single position detector could be used, e.g. an area sensor for detecting an orientation of the printing plate.

Further, the processor can be arranged to generate the release signal upon receipt of the start position signal of a reduced set of position detectors, especially if a relatively large number of position detectors is used for detecting the actual position of the printing plate.

In principle, the sequence of horizontal movements in the process of positioning the printing plate can. be interchanged, viz. first securing the orientation of the printing plate by moving the position detectors along the second path H₂ and then moving the printing plate along the first horizontal path.

Other such variants will be obvious for the person skilled in the art and are considered to lie within the scope of the invention as formulated in the following claims.

1. A loading device for loading a printing plate from a multiple plate stack to an input section of a plate imaging bed in an imaging system for performing a computer-to-plate imaging process on printing plates, the loading device comprising a picking unit for picking a printing plate from the multiple plate stack and for transporting the plate to the input section, the loading device further being arranged to release the plate after the plate has been positioned in a starting position for autonomous manipulation by the imaging system.

2. A loading device according to claim 1, associated with a processor that is connected with at least one position detector for detecting the starling position of the printing plate and for sending a start position signal to the processor, the processor being arranged to send a release signal to the loading device for releasing the printing plate upon receipt of the start position signal of a predefined number of the at least one position detector.

3. A loading device according to claim 1, wherein the picking unit comprises a pair of engagement elements for picking the printing plate, wherein the pair of engagement elements during operation is pivotable with respect to a substantially vertical pivot axle.

4. A loading device according to claim 3, further comprising a pivot actuator for pivoting the pair of engagement elements with respect to the substantially vertical pivot axis.

5. An input section of a plate imaging bed in an imaging system for performing a computer-to-plate imaging process on printing plates, the input section being arranged for receiving a print plate from a picking unit, the input section further comprising at least one position detector for detecting a starting position of the printing plate for autonomous manipulation by the imaging system, the at least one position detector further being arranged to generate upon detection of the starting position of the printing plate a start position signal for releasing the plate.

6. An input section according to claim 5, wherein in the starting position of the printing plate at least two position detectors are arranged along a long side of the printing plate and at least one position detector is arranged along a short side of the received printing plate.

7. A method for loading a printing plate from a multiple plate stack to an input section of a plate imaging bed in an imaging system for performing a computer-to-plate imaging process on printing plates, the method comprising picking a printing plate from the multiple plate stack and transporting the plate to the input section, further comprising positioning the plate in a starting position for autonomous manipulation by the imaging system and releasing the plate after the positioning step.

8. A. method according to claim 7, wherein the positioning step comprises detecting the printing plate by means of at least one position detector.

9. A method according to claim 7, wherein the positioning step further comprises sending a start position signal to a processor upon detecting that the loading plate is in the start position, and sending a release signal for releasing the printing plate upon receipt by the processor of a start position signal of a predefined number of the at least one position detector.

10. A method according to claim 7, wherein the positioning step comprises moving the printing plate along a first substantially horizontal path until at least one position detector detects the printing plate.

11. A method according to claim 10, wherein the positioning step comprises moving at least one position detector along a second substantially horizontal path substantially transverse with respect to the first horizontal path until the at least one position detector detects the printing plate.

12. A computer system, comprising a processor connected with at least one position detector, the processor being arranged to send upon receipt of a start position signal of the at least one position detector detecting that the plate is in a starting position for autonomous manipulation by the imaging system, a release signal to a loading device for loading a printing plate from a multiple plate stack to an input section of a plate imaging bed in an imaging system for performing a computer-to-plate imaging process on printing plates, such that the loading device releases the printing plate.

13. A computer program product for loading a printing plate from a multiple plate stack to an input section of a plate imaging bed in an imaging system for performing a computer-to-plate imaging process on printing plates, which computer program product comprises instructions for causing a processor to send upon receipt of a start position signal of at least one position detector detecting that the plate is in a starting position for autonomous manipulation by the imaging system, a release signal to a loading device for loading the printing plate, such that the loading device releases the printing plate.
